(19) United States
(12) Patent Application Publication
(10) Pub. No.: US 2026/0356392 A1
(43) Pub. Date: Nov. 12, 2026

(54) VEHICLE TO BICYCLE COMMUNICATION SYSTEM

(71) Applicant: Also, Inc., Palo Alto, CA (US)

(72) Inventor: Jonathan Louis HALL, Menlo Park, CA (US)

(73) Assignee: Also, Inc., Palo Alto, CA (US)

(21) Appl. No.: 19/199,506

(22) Filed: May 6, 2025

(51) Int. Cl. B60W 60/00; G08G 1/16

(52) U.S. Cl. CPC B60W 60/0027; G08G 1/161; B60W 2554/4026; B60W 2554/4041; B60W 2554/4042; B60W 2554/4044; B60W 2556/50; B60W 2556/65; B60W 2710/18; B60W 2710/20; B60W 2720/10; B60W 2720/24; B60W 2754/10

(57) ABSTRACT

A vehicle can include an autonomous vehicle control system. The autonomous vehicle control system can include one or more processors, coupled with memory. The one or more processors can receive, via a communication device, at least one signal which includes data associated with at least one bicycle, determine a position of the at least one bicycle with respect to a position of the vehicle, generate one or more control parameters for at least one of a drivetrain of the vehicle, a braking system of the vehicle, or a steering component of the vehicle, and control subsequent movement or operation of the vehicle in accordance with the one or more control parameters.

### INTRODUCTION

Vehicles can include sensors to detect one or more objects.

### SUMMARY

The present disclosure is directed to one or more components, devices, systems, or modules for a vehicle. The systems can include vehicle control systems, adaptive cruise control systems, lane monitoring systems, blind spot detection systems, automatic braking systems, among other advanced driver assistance systems. For example, an autonomous vehicle control system can be outfitted on or otherwise included in the vehicle. The autonomous vehicle control system can prompt or otherwise cause at least one bicycle to transmit data, via one or more signals, to determine or otherwise identify the location (e.g., bearing, heading, position, placement, other spatial arrangement) of the bicycle.

At least one aspect is directed to a vehicle. The vehicle can include a communication device. The communication device can communicate with at least one bicycle. The vehicle can include one or more processors, coupled with memory. The one or more processors can receive, via the communication device, at least one signal which includes data associated with the at least one bicycle. The one or more processors can determine, based at least on the data associated with the at least one bicycle, a position of the at least one bicycle with respect to a position of the vehicle. The one or more processors can generate, responsive to determination of the position of the at least one bicycle, one or more control parameters for at least one of a drivetrain of the vehicle, a braking system of the vehicle, or a steering component of the vehicle. The one or more processors can control subsequent movement or operation of the vehicle in accordance with the one or more control parameters.

At least one aspect is directed to an autonomous vehicle control system. The autonomous vehicle control system can include one or more processors, coupled with memory. The one or more processors can receive, via a communication device of a vehicle, at least one signal which includes data associated with at least one bicycle. The one or more processors can determine, based at least on the data associated with the at least one bicycle, a position of the at least one bicycle with respect to a position of the vehicle. The one or more processors can generate, responsive to determination of the position of the at least one bicycle, one or more control parameters for at least one of a drivetrain of the vehicle, a braking system of the vehicle, or a steering component of the vehicle. The one or more processors can control subsequent movement or operation of the vehicle in accordance with the one or more control parameters.

At least one aspect is directed to a method. The method can include providing an autonomous vehicle control system. The autonomous vehicle control system can include one or more processors, coupled with memory. The one or more processors can receive, via a communication device of a vehicle, at least one signal which includes data associated with at least one bicycle. The one or more processors can determine, based at least on the data associated with the at least one bicycle, a position of the at least one bicycle with respect to a position of the vehicle. The one or more processors can generate, responsive to determination of the position of the at least one bicycle, one or more control parameters for at least one of a drivetrain of the vehicle, a braking system of the vehicle, or a steering component of the vehicle. The one or more processors can control subsequent movement or operation of the vehicle in accordance with the one or more control parameters.

At least one aspect is directed to a method. The method can include receiving, by one or more processors of an autonomous vehicle control system for a vehicle, via a communication device, at least one signal which includes data associated with at least one bicycle. The method can include determining, by the one or more processors, based at least on the data associated with the at least one bicycle, a position of the at least one bicycle with respect to a position of the vehicle. The method can include generating, by the one or more processors, responsive to determining the position of the at least one bicycle, one or more control parameters for at least one of a drivetrain of the vehicle, a braking system of the vehicle, or a steering component of the vehicle. The method can include controlling, by the one or more processors, subsequent movement or operation of the vehicle in accordance with the one or more control parameters.

At least one aspect is directed to a system. The system can include at least one bicycle. The at least one bicycle can include a first communication device. The first communication device can communicate with a second communication device of a vehicle. The at least on bicycle can include one or more first processors, coupled with first memory.

The one or more first processors can transmit, to the second communication device, at least one signal which includes data associated with the at least one bicycle. The system can include the vehicle. The vehicle can include the second communication system. The vehicle can include an autonomous vehicle control system. The autonomous vehicle control system can include one or more second processors, coupled with second memory. The one or more second processors can receive, via the second communication device, the at least one signal which includes the data associated with the at least one bicycle. The one or more second processors can determine, based at least on the data associated with the at least one bicycle, a position of the at least one bicycle with respect to a position of the vehicle. The one or more second processors can generate, responsive to determination of the position of the at least one bicycle, one or more control parameters for at least one of a drivetrain of the vehicle, a braking system of the vehicle, or a steering component of the vehicle. The one or more second processors can control subsequent movement or operation of the vehicle in accordance with the one or more control parameters.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with some aspects.

FIG. 2 depicts a bicycle, in accordance with some aspects.

FIG. 3 depicts a block diagram of system architecture to facilitate communication between at least one vehicle and at least one bicycle, in accordance with some aspects.

FIG. 4 is a block diagram of a system that includes the electric vehicle of FIG. 1 and the bicycle of FIG. 2, in accordance with some aspects.

FIG. 5A is a flow diagram of a process for an autonomous vehicle control system, in accordance with some aspects.

FIG. 5B is a flow diagram of a process for facilitating communication between a vehicle and at least one bicycle, in accordance with some aspects.

FIG. 6 is a block diagram illustrating an architecture for a computer system, in accordance with some aspects.

### DETAILED DESCRIPTION

Following below are more detailed descriptions of various concepts related to, and implementations of, methods, apparatuses, and systems of one or more assemblies for a bicycle. The various concepts introduced above and discussed in greater detail below may be implemented in any of numerous ways.

The present disclosure is directed to one or more components, devices, systems, or modules for a vehicle. The systems can include vehicle control systems, adaptive cruise control systems, lane monitoring systems, blind spot detection systems, automatic braking systems, among other advanced driver assistance systems. For example, the vehicle can include an autonomous vehicle control system to facilitate communication between one or more devices of the vehicle and one or more devices of at least one bicycle. The autonomous vehicle control system can prompt or otherwise elicit at least one bicycle to transmit one or more signals. The signals can include, indicate, or otherwise allow for the autonomous vehicle control system to determine the location of the bicycle. For example, the autonomous vehicle control system can transmit one or more pulse or ping signals to trigger, prompt, or otherwise cause a communication device of the bicycle to transmit one or more responses or replies. The responses or replies can include information to determine or identify the location of the bicycle. For example, the bicycle can include a transponder which transmits signals that include an indication of a location of the bicycle. As another example, the vehicle can include one or more sensors (disposed at one or more discrete, separate, or various locations on the vehicle) such that the autonomous vehicle control system can execute signal triangulation to determine the location of the bicycle.

In urban environments, the interaction between vehicles and bicycles is particularly challenging due to the high density of traffic and the diverse range of road users. These environments can include bustling city centers, residential neighborhoods, commercial districts, and areas with heavy pedestrian activity. Bicycles often navigate through narrow lanes, busy intersections, and areas with limited visibility, such as streets lined with parked cars or construction zones. Additionally, urban environments can feature bike lanes that are not always clearly marked or separated from vehicle traffic, further complicating the coexistence of bicycles and vehicles.

Currently, vehicles and bicycles lack the infrastructure to communicate directly with each other, which poses significant challenges. While vehicles can be equipped with various sensors and systems designed to detect obstacles and other vehicles, these systems often fall short when it comes to detecting bicycles. Technologies such as RADAR, LIDAR, and cameras are commonly used in vehicles to detect objects and navigate safely. However, these systems can struggle to detect bicycles due to the smaller size of bicycles, unpredictable movements, and the complexity of urban environments. For instance, a bicycle might suddenly appear from behind a parked car or make a quick turn at an intersection, leaving the vehicle little time to react.

The disclosed technical solutions include a vehicle equipped with an autonomous vehicle control system that facilitates communication with bicycles. The autonomous vehicle control system can facilitate the transmission and receipt of signals between the vehicle and at least one bicycle. The autonomous vehicle control system can determine, using information provided by or received from the at least one bicycle, a precise, estimated, or predicted location of the at least one bicycle. The autonomous vehicle control system can subsequently adjust, or control operation or movement of the vehicle based on the location of the bicycle.

Communication technologies, such as Bluetooth, Wi-Fi, or dedicated short-range communication (DSRC) can be outfitted on or included with the at least one bicycle. For example, the bicycle can include a device (e.g., a communication device, a transceiver, a receiver, a transponder, etc.) that continuously or semi-continuously emits signals which include or indicate location data (e.g., a location of the bicycle). When the vehicle (including the autonomous vehicle control system) comes within range of the signals transmitted by the bicycle, the autonomous control system can detect or receive the signals.

The autonomous vehicle control system can implement or execute one or more techniques to determine or identify the location of the bicycle. For example, the autonomous vehicle control can perform signal triangulation to determine the location of the bicycle. The autonomous vehicle control system can implement signal triangulation by measuring the time it takes for one or more signals to travel between the bicycle and multiple receivers on the vehicle. As another example, the bicycle can transmit signals that include global position system (GPS) coordinates of the bicycle to pinpoint the location of the bicycle.

The autonomous vehicle control system can control one or more components or systems of the vehicle based on the location of the bicycle. For example, the autonomous vehicle control system can utilize an adaptive cruise control system of the vehicle to slow down (e.g., brake) the vehicle. As another example, the autonomous vehicle control system can control the vehicle to change lanes or otherwise maneuver the vehicle.

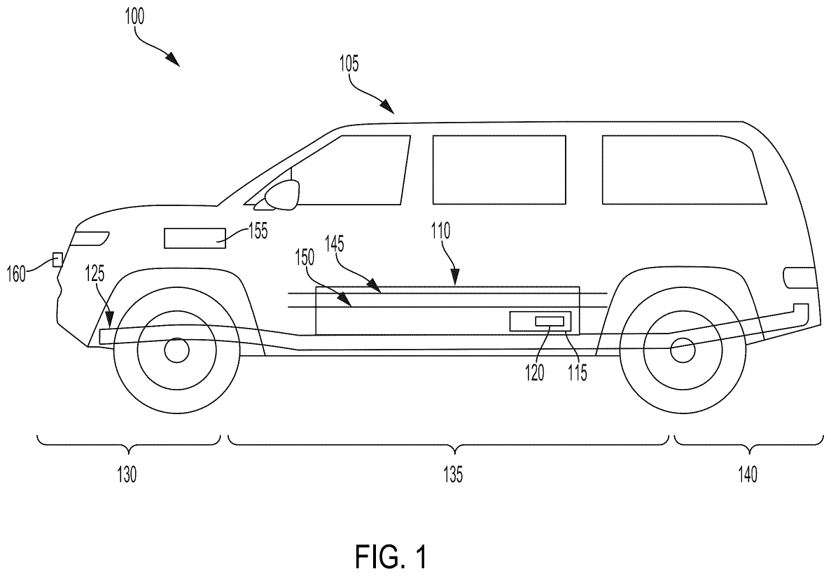

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building.

Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 (or battery modules), or battery cells 120 to power the electric vehicles. The electric vehicle 105 can include a chassis 125 (e.g., a frame, internal frame, or support structure).

The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the batteries 115 or the battery cells 120 with other electrical components of the electric vehicle 105 to provide electrical power to various systems or components of the electric vehicle 105.

The electric vehicle 105 can include at least one autonomous vehicle control system 155 and at least one sensor 160. The autonomous vehicle control system 155 can be communicable coupled with or otherwise in communication with one or more devices, components, or system of the electric vehicle 105. For example, the autonomous vehicle control system 155 can be in communication, via a controller area network (CAN) bus, with an adaptive cruise control system of the electric vehicle 105. As another example, the autonomous vehicle control system 155 can be in communication, via a wiring harness, with a lane monitoring system of the electric vehicle 105. As even another example, the autonomous vehicle control system 155 can be in communication with one or more electronic control units of the electric vehicle 105.

The autonomous vehicle control system 155 can include one or more components, devices, modules, circuitry, or other elements to facilitate the control or operation of the electric vehicle 105. For example, the autonomous vehicle control system 155 can transmit one or more signals to control a drivetrain of the electric vehicle 105 such that the electric vehicle 105 is propelled or otherwise moved. As another example, the autonomous vehicle control system 155 can transmit one or more signals to control a braking system of the electric vehicle 105 to stop or otherwise slow down a speed of the electric vehicle 105.

The sensors 160 can include at least one of radio detection and ranging (RADAR) sensors, light detection and ranging (LIDAR) sensors, cameras, video devices, optical devices, or object detection devices. For example, the sensors 160 can include a RADAR sensor to transmit or receive radio waves. The sensors 160 can be disposed, located, positioned, placed, or otherwise situated on the electric vehicle 105. For example, the sensors 160 can be disposed on an external surface of the electric vehicle 105. As another example, one or more first sensors 160 can be located on a front bumper of the electric vehicle 105 and one or more second sensors 160 can be located on a rear bumper of the electric vehicle 105.

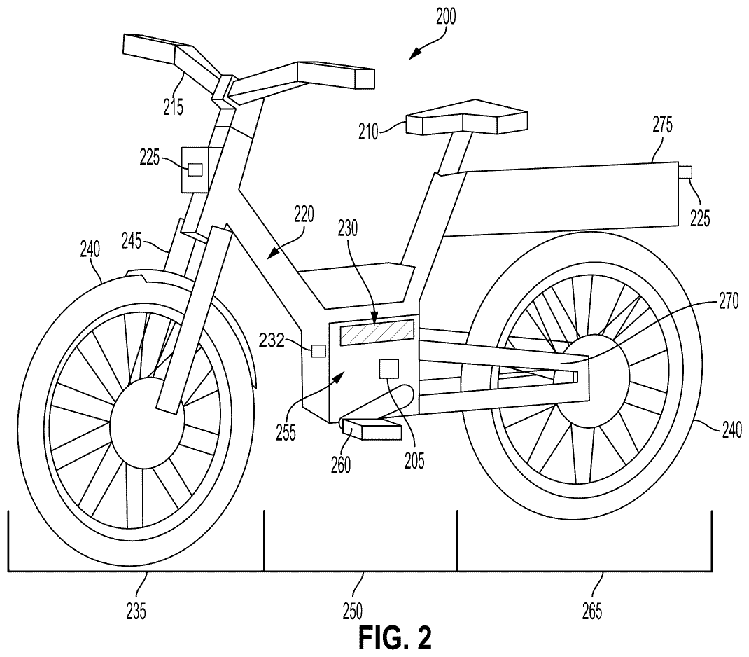

FIG. 2 depicts an example perspective view of a bike 200. The bike 200 can be an electric bike installed with at least one battery pack 205. The bike 200 can include at least one bicycle. The bike 200 can be a human-operated bike. The bike 200 can include single rider bicycles, tandem bicycles, cargo bicycles, motor-assist bicycles, pedicabs, electric-assist bicycles, road bicycles, mountain bicycles, or unicycles, among others. The battery pack 205 can also be used as an energy storage system to power a building, such as a residential home or commercial building. The bike 200 can be fully electric or partially electric (e.g., pedal-powered) and further, the bike 200 can be fully autonomous, partially autonomous, semi-autonomous, or unmanned. The bike 200 can also be human operated or non-autonomous.

A human operator or rider of the bike 200 can sit on a seat 210 to operate the bike 200. The rider of the bike 200 can steer, grip, balance, or otherwise control the bike 200 using handlebar 215. The rider or operator of the bike 200, for which the seat 210 can support, can refer to or include a primary occupant of the bike 200.

The bike 200 can include a frame 220. The frame 220 can support various components of the bike 200, such as the handlebar 215, the seat 210, the battery pack 205, and at least one light 225. The frame 220 can span a front portion 235. The front portion 235 can support, be coupled with, or include, for example, a wheel 240 of the bike 200, a fork 245 of the bike 200, the handlebar 215, the light 225, among other components. The bike 200 can include two or more wheels 240 (e.g., a front wheel 240 and a rear wheel 240).

The frame 220 can span a middle portion 250. The middle portion 250 can support, be coupled with, or include, for example, the seat 210, the battery pack 205, a crank shaft or drive mechanism 255 of the bike 200, or a pedal 260 of the bike 200, among other components. The frame 220 can include a rear portion 265. The rear portion 265 can support, be coupled with, or include, for example, a rear wheel 240 of the bike 200, the light 225, a drive train 270 of the bike 200, a rack assembly 275 of the bike 200, or among other components. The battery pack 205 can be disposed anywhere within the frame 220. The drive mechanism 255 can refer to or include a series propulsion system.

The battery pack 205 can include at least one battery, at least one battery module, or at least one battery cell. The battery pack 205 can be electrically coupled with the bike 200 (e.g., the drive mechanism 255, the light 225, or some other components). For example, the battery pack 205 can provide electrical energy to the bike 200 to power the bike 200.

The battery pack 205 can be installed or placed within the bike 200. For example, the battery pack 205 can be installed on the frame 220 of the bike 200 within one or more of the front portion 235, the middle portion 250, or the rear portion 265. The battery pack 205 can be integrally coupled with the frame 220 such that it is not removable. The battery pack 205 can be detachably coupled with the frame 220 such that in can be removed (e.g., to charge the battery pack 205).

The battery pack 205 can include or connect with at least one busbar, e.g., a current collector element. For example, the busbar can include electrically conductive material to connect or otherwise electrically couple the battery pack 205 with other electrical components of the bike 200 to provide electrical power to various systems or components of the bike 200, such as the drive mechanism 255, or some other system.

The bike 200 can include one assemblies electrically coupled with the battery pack 205. For example, the battery pack 205 can be electrically coupled with a receiver of an assembly to facilitate the actuation or movement of one or more components of the receiver. In this way, the receiver can be configured to be controlled or actuated electronically via power provided by the battery pack 205, rather than being controlled or actuated manually or mechanically (e.g., via some manual action of an operator). The battery pack 205 can provide power to other components of the bike 200 (e.g., the drive mechanism 255, the light 225, or some other component) simultaneously, separately, in sequence, or in some other manner.

The bike 200 can be electrically propelled or manual propelled. For example, the bike 200 can include a series hybrid propulsion system. As another example, the battery pack 205 can provide power to the drive mechanism 255 to power the drive train 270 to propel the bike 200 (e.g., propel the bike by causing the at least one wheel 240 to rotate). As another example, an operator of the bike 200 can operate or otherwise move the pedals 260 to manual move or power the drive train 270.

The bike 200 or one or more components thereof can include at least one processing circuit 230 and at least one communication device 232. For example, a controller of the bike 200 can include the processing circuit 230. As another example, the processing circuit 230 can be included in a control mechanism that facilitates control (e.g., lock, unlock, actuation, etc.) of an electronic lock or electronic lock mechanism. The communication device 232 can transmit or receive one or more signals. For example, the communication device 232 can include a transponder. As another example, the communication device 232 can include a transceiver. The communication device 232 can include at least one communication device described herein. The communication device 232 can implement or otherwise execute one or more communication protocols (e.g., Ultra-wideband, Bluetooth, Wi-Fi, ethernet, cellular, Zigbee, dedicated short range communication (DSRC), etc.).

The processing circuit 230 can refer to or include one or more processors and memory. For example, the processing circuit 230 can include one or more processors that are coupled with memory. Memory can refer to or include one or more of hardware devices or storage devices that can store instructions (e.g., executable code, firmware, software, functions, etc.). The instructions can, when executed by the one or more processors, cause the one or more processors to implement at least one process, action, step, or function described herein. The processing circuit 230 can be electrically coupled with the battery pack 205 to receive power from the battery pack 205.

The processing circuit 230 can be communicably coupled with one or more components of the bike 200. For example, the processing circuit 230 can communicate with the battery pack 205 to control a discharge of power by the battery pack 205. As another example, the processing circuit 230 can provide, generate, or otherwise transmit one or more signals, which cause the drive mechanism 255 to activate or deactivate. As even another example, the processing circuit 230 can transmit one or more signals to a locking mechanism of the bike 200. The processing circuit 230 can detect one or more inputs. For example, the processing circuits 230 can detect inputs, received by a network interface of the bike 200, to lock or unlock a lock or locking mechanism of the bike 200. Stated otherwise, the processing circuit 230 can detect one or more inputs provided to or received by the bike 200 or one or more components thereof. The inputs can include one requests to lock or unlock a locking mechanism of an electronic lock.

The processing circuit 230 can implement or otherwise execute one or more control actions based on detected inputs. For example, the processing circuit 230 can actuate or otherwise control a locking mechanism to lock or unlock a lock that is securing the bike 200 to one or more objects. Stated otherwise, the processing circuit 230 can control the lock mechanism to switch a lock from a locked state to an unlocked state or vice versa. The processing circuit 230 can establish communication with one or more components of the bike. For example, the processing circuit 230 can establish communication with an electronic lock. As another example, the processing circuit 230 can establish communication with one or more computing devices (e.g., smart phone, tablet, computer, server, remote system, etc.). The processing circuit 230 can establish communication by transmitting one or more signals. For example, the processing circuit 230 can transmit one or more signals, via a controller area network (CAN) bus, to establish communication. As another example, the processing circuit 230 can transmit one or more signals, via a network interface, to establish communication.

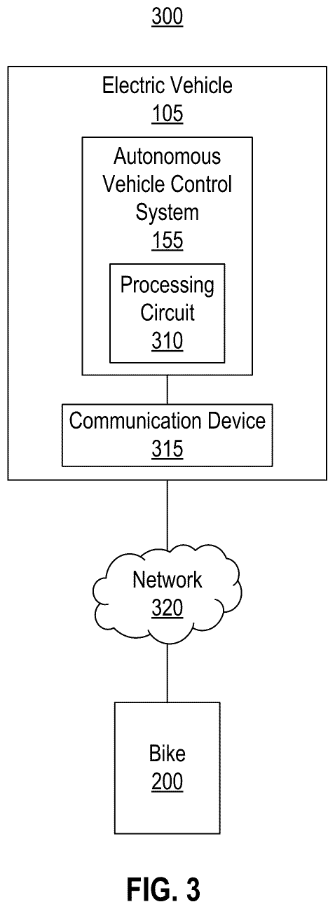

FIG. 3 depicts a block diagram of a system architecture 300, in accordance with some aspects. The system architecture 300 can include at least one component, device, system, module, circuitry, or assembly described herein. For example, as shown in FIG. 3, the system architecture 300 includes the electric vehicle 105 and the bike 200. As another example, the system architecture 300 can include one or more components, sub-components, assemblies, or sub-assemblies. The electric vehicle 105 and the bike 200 can interface with, interact with, or otherwise communicate with one another via at least one network 320. For example, the electric vehicle 105 and the bike 200 can transmit one or more data signals or data transmissions via the network 320. The network 320 can include at least one of a local area network (LAN), a wide area network (WAN), a telephone network (such as the Public Switched Telephone Network (PSTN)), a personal area network (PAN), Wi-Fi, a Controller Area Network (CAN), wireless link, intranet, the Internet, a cellular network, and/or combinations thereof.

The electric vehicle 105 or one or more components thereof can include at least one processing circuit 310 and at least one communication device 315. For example, as shown in FIG. 3, the autonomous vehicle control system 155 includes the processing circuit 310. The processing circuit 310 can include at least one hardware device, processing device, computing device, or circuitry described herein. For example, processing circuit 310 can include one or more processors coupled with memory. The one or more processors, coupled with memory, can execute, implement, perform, or otherwise facilitate one or more steps, processes, functions, or methods described herein. For example, the one or more processors (e.g., the processing circuit 310) can facilitate the transmission or receipt of one or more signals or data transmissions.

The communication device 315 can include one or more of network communication devices, network interfaces, or other possible communication interfaces. The communication device 315 can be or include wired or wireless communications interfaces (e.g., jacks, antennas, transmitters, receivers, transceivers, wire terminals, etc.) for conducting data communications between the electric vehicle 105 and the bike 200. The communication device 315 can implement direct communication (e.g., local wired, wireless communications, etc.) or communication over a network (e.g., the network 320). For example, the communication device 315 can include an Ethernet card and port for sending and receiving data via an Ethernet-based communications link or network. The communication device 315 can also include a Wi-Fi transceiver for communicating via a wireless communications network (e.g., the network 320). The communication device 315 can include a power line communications interface. The communication device 315 can include an Ethernet interface, a USB interface, a serial communications interface, or a parallel communications interface. The communication device 315 can interface with, interact with, and/or otherwise communicate with at least one of various systems and/or components described herein.

The processing circuit 310 can receive one or more signals. For example, the processing circuit 310 can receive data transmission (e.g., signals) via the communication device 315. The processing circuit 310 can receive the signals from one or more devices. For example, the processing circuit 310 can receive signals, via the network 320, from the bike 200. As another example, the processing circuit 310 can receive signals from one or more computing devices (e.g., smart phones, tablets, computers, servers, etc.).

The processing circuit 310 can receive signals which include data associated with the bike 200. For example, the processing circuit 310 can receive, from the bike 200, one or more responses or replies to a ping or prompt. As another example, the processing circuit 310 can include signals having a payload that corresponds to the bike 200. The contents (e.g., payload, data, etc.) of the signals can include, indicate, or identify a location, a position, a placement, or a spatial arrangement of the bike 200. For example, the bike 200 (e.g., the communication device 232) can transmit a signal that includes location information with respect to the bike 200.

The bike 200 can provide data that includes one or more sets of information. For example, the bike 200 can provide data that includes an identification of the communication device 232 (e.g., a device ID, a serial number, a type of device, a communication protocol, etc.). As another example, the bike 200 can provide data that includes communication protocols for which the communication device 232 can implement. Stated otherwise, the bike 200 can provide an indication of one or more ways for which the bike 200 can transmit or receive signals.

The processing circuit 310 can determine a position of the bike 200. For example, the processing circuit 310 can determine a placement, an arrangement, a configuration, or a spatial aspect of the bike 200 with respect to the electric vehicle 105. Stated otherwise, the processing circuit 310 can determine a position of the bike 200 relative to the electric vehicle 105. The processing circuit 310 can determine the position of the bike 200 based on the signals transmitted by the bike 200. For example, the processing circuit 310 can implement, using the sensors 160, signal triangulation to determine the position of the bike 200. In this example, the bike 200 can transmit one or one signals (e.g., radio waves, etc.) and the processing circuit 310 can compare one or more points in time for which the sensors 160 detected or received the radio waves. Based on the differences in the points in time, the processing circuit 310 can determine a position of the bike 200.

The processing circuit 310 can generate one or more control parameters. For example, the processing circuit 310 can generate control parameters for one or more electronic control units of the electric vehicle 105. As another example, the processing circuit 310 can generate control strategies, control signals, or triggers which cause the electric vehicle 105 to perform or take one or more actions. The processing circuit 310 can generate control parameters for at least one of a drivetrain of the electric vehicle 105, a braking system of the electric vehicle 105, or a steering component of the electric vehicle 105. For example, the processing circuit 310 can generate control parameters which cause the electric vehicle 105 (responsive to activation of the braking system) to slow down or otherwise stop. As another example, the processing circuit 310 can generate control parameters which cause the electric vehicle 105 (responsive to activation of the steering component) to change lanes.

The processing circuit 310 can control one or more aspects of the electric vehicle 105. For example, the processing circuit 310 can control a directionality (e.g., movement) of the electric vehicle 105 while the electric vehicle 105 is travelling on a road. As another example, the processing circuit 310 can cause the electric vehicle 105 to take one or more actions (e.g., operation). Stated otherwise, the processing circuit 310 can control how the electric vehicle 105 behaves or performs responsive to or based on the position of the bike 200. The processing circuit 310 can control the subsequent movement of operation of the electric vehicle 105 to adjust at least one of a speed of the electric vehicle 105 or a direction of travel of the electric vehicle 105. The processing circuit 310 can cause one or more devices, of the electric vehicle 105, to take or perform one or more actions. For example, the processing circuit 310 can cause an audible device (e.g., a speaker, a horn, etc.) of the electric vehicle 105 to produce an output such as, a horn, a beep, or other possible audible output.

The processing circuit 310 can transmit one or more signals to prompt the bike 200. For example, the processing circuit 310 can transmit a ping or a pulse, which upon receipt by the bike 200, causes the bike 200 to transmit or otherwise provide a response. As another example, the processing circuit 310 can transmit one or more signals which includes requests for the bike 200. The requests could be for the bike 200 to provide data which indicates or identify a current location of the bike 200. The requests can prompt the bike 200 to emit one or more radio waves such that the sensors 160 can detect or identify (within space) the bike 200. The requests can prompt the bike 200 to emit one or more first signals in accordance with a communication protocol or signal type.

The processing circuit 310 can detect one or more sets of information or data included in signals transmitted by the bike 200. For example, the processing circuit 310 can extract a payload from signals transmitted by the bike 200. As another example, the processing circuit 310 can identify plain text included within the signals. The processing circuit 310 can detect information such as communication protocols, types of communication devices, types of sensors, or other possible hardware installed on the bike 200. For example, the processing circuit 310 can detect, based on the signals transmitted by the bike 200, that the bike 200 is able to communicate on at least one of cellular communication, on the ultra-wideband, or Bluetooth. As another example, the processing circuit 310 can detect a type of signal for which the bike 200 can share or otherwise provide. Stated otherwise, the processing circuit 310 can detect that the bike 200 can transmit radio waves, emit light waves, or other possible types of signals.

The processing circuit 310 can extract one or more sets of information which indicate or identify one or more operational characteristics of the bike 200. For example, the processing circuit 310 can extract, from one or more signals transmitted by the bike 200, a direction of travel of the bike 200. Stated otherwise, the processing circuit 310 can extract information which indicates or identifies a heading of the bike 200, a movement of the bike 200, or a path for which the bike 200 is traveling. As another example, the processing circuit 310 can extract or identify a speed of the bike 200. Stated otherwise, the processing circuit 310 can determine how fast or a rate of speed for which the bike 200 is currently moving along a road.

The processing circuit 310 can extract information which provides an indication of the position of the bike 200. For example, the bike 200 can transmit one or more signals which include or identify GPS coordinates of the bike 200. The processing circuit 310 can extract, from the one or more signals, the GPS coordinates. The processing circuit 310 can, using one or more sets of extracted information, determine the position of the bike 200. For example, the processing circuit 310 can determine the position of the bike 200 by comparing a GPS coordinate of the electric vehicle 105 with the GPS coordinates provided by the bike 200. As another example, the processing circuit 310 can determine the position of the bike 200 by tracking the direction of the travel of the bike 200 and the speed of the bike 200.

Stated otherwise, based on an amount of time elapsed since receiving the signals from the bike 200, the processing circuit 310 can determine where the bike 200 is located, in space, based on the direction of travel and the speed that the bike 200 is traveling at. The amounts of time can refer to or include at least one predetermined amount of time or predetermined time interval.

The processing circuit 310 can transmit one or more signals in accordance with one or more aspects of the bike 200. For example, the processing circuit 310 can transmit signals, in accordance with a communication protocol, based on the bike 200 having provided an indication that the bike 200 can communicate using the communication protocol. As another example, the processing circuit 310 can transmit one or more signals, based on an identifier of a given communication device, based on the bike 200 having provided an indication that the given communication device is included in the bike 200.

The processing circuit 310 can transmit one or more signals at one or more time intervals or points in time. For example, the processing circuit 310 can transmit a ping or pulse at 1 minute intervals. Stated otherwise, the processing circuit 310 can transmit a ping every minute. As another example, the processing circuit 310 can transmit a ping based on an amount of time that has elapsed since previously sending a signal to the bike 200 or receiving a signal from the bike 200. Stated otherwise, upon a given amount of time having elapsed since receiving a signal from the bike 200, the processing circuit 310 can transmit a signal to prompt the bike 200 to provide subsequent or current information with respect to the bike 200.

The processing circuit 310 can receive one or more signals which indicate changes with respect to the bike 200. For example, the processing circuit 310 can receive a subsequent signal which provides an indication of a change in the position of the bike 200. As another example, the processing circuit 310 can receive a signal which provides an indication of a change in operation of the bike 200. The change in the operation of the bike 200 can refer to or include a change in the speed of the bike 200, a change in a direction of travel of the bike 200, or a change in a communication protocol or communication device of the bike 200.

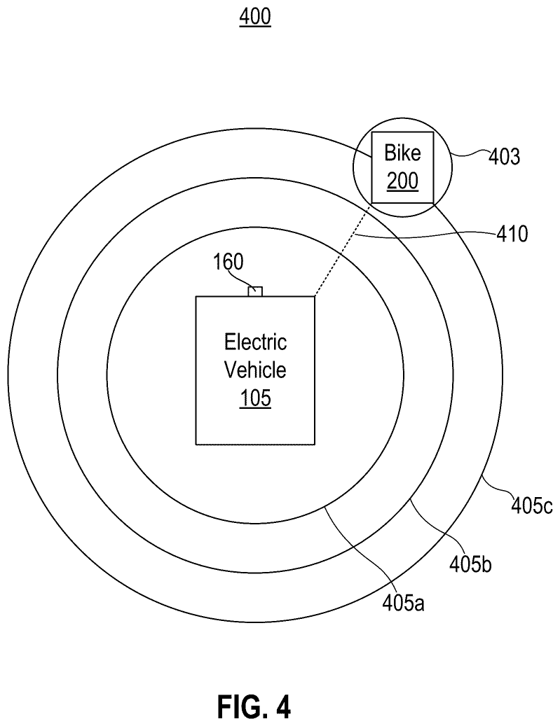

FIG. 4 depicts a block diagram of a system 400, in accordance with some aspects. The system 400 can include the electric vehicle 105 and the bike 200. For example, the system 400 can represent or include an environment for which the electric vehicle 105 and the bike 200 are located in. The system 400 can include a geographical region or area. For example, the system 400 can include a city. The bike 200 can include at least one position 403. For example, as shown in FIG. 2, the position 403 (e.g., the position of the bike 200) is illustrated as being with respect or relative to a position of the electric vehicle 105. Stated otherwise, the determination or interpretation of the position 403 can be based on or relative to a location or position of the electric vehicle 105.

The sensors 160 can collect data with respect to one or more zones 405. For example, the sensors 160 can emit one or more signals (e.g., radio waves, light waves, etc.) which include one or more distances of travel (e.g., how far the signals can reach). As another example, the sensors 160 can collect data with respect to one or more distances away from the electric vehicle 105. The zones 405 can surround or include the electric vehicle 105. For example, the zones 405 can include an area for which the electric vehicle 105 is included in or otherwise encompassed by. As another example, the zones 405 can refer to or include an area of detection. The zones 405 can include one or more dimensions (e.g., areas, volumes, sizes, etc.). For example, a zone 405c can include a first area and a zone 405b can include a second area. The dimensions of the zones 405 can refer to or include an amount of space between the electric vehicle 105 and a border of a given zone 405.

The processing circuits 310 can receive one or more sets of information collected by the sensors 160. For example, the processing circuits 310 can receive proximity data (e.g., results or outcomes of transmitting the signals within or across the zones 405). As another example, the processing circuits 310 can receive data which indicates detected objects or a presence of an object within a given zone 405 of the zones 405. The processing circuit 310 can detect that the bike 200 is located within a zone 405c (e.g., a first zone) based on the data collected by the sensors 160. For example, the processing circuit 310 can receive, from the sensors 160, information which indicates one or more detected objects within the zones 405. As another example, the processing circuits 310 can detect, based on one or more signals detected by or captured by the sensors 160, that an object is located within at least one of the zones 405.

The processing circuit 310 can determine that the bike 200 is the object located within at least one of the zones 405 based on the information provided by the bike 200. For example, the processing circuit 310 can determine that the bike 200 is located in the zone 405c based on detected radio waves or light waves corresponding to the communication device 232 (e.g., the waves were transmitted by the bike 200). As another example, the processing circuit 310 can determine that the bike 200 is the object located within at least one of the zones 405 based on one or more responses to a pulse signa. Stated otherwise, the processing circuit 310 can transmit, in the vicinity of the detected object, a pulse or ping signal and the processing circuit 310 can determine, based on a response, that the detected object is the bike 200.

The processing circuit 310 can perform or implement at least one type of analysis on the data collected by the sensors 160. For example, the processing circuit 310 can implement an image analysis on image frames obtained by the sensors 160. As another example, the processing circuit 310 can implement bounding box analysis to detect objects within the data collected by the sensors 160. The processing circuit 310 can detect the bike 200 within the zone 405c based on data (which corresponds to the zone 405c) indicating a detected object. Stated otherwise, the processing circuit 310 can detect that the bike 200 is within the zone 405c based on a detected object having by detected within a boundary or dimension that represents the zone 405c.

The processing circuit 310 can transmit one or more prompts responsive to detection or the bike 200. For example, the processing circuit 310 can transmit a first prompt responsive to detecting the bike 200 within the zone 405c. The processing circuit 310 can transmit the first prompt in accordance with one or more communication protocols. For example, the processing circuit 310 can transmit the first prompt to conform to Bluetooth communication. As another example, the processing circuit 310 can transmit the first prompt in accordance with the ultra-wideband.

The processing circuit 310 can detect that bike 200 has changed or moved between one or more of the zones 405. For example, the processing circuit 310 can detect that the bike 200 moved from the zone 405c to a zone 405b. As another example, the processing circuit 310 can detect that a distance 410 (between the electric vehicle 105 and the bike 200) has changed (e.g., increased, decreased, etc.). Stated otherwise, the processing circuit 310 can detect, responsive to the bike 200 having moved from the zone 405c to the zone 405b, that the bike 200 has moved towards or is closer to the electric vehicle 105.

The processing circuit 310 can transmit one or more signals based on the bike 200 being in a given zone 405. For example, while the bike 200 is located in the zone 405c, the processing circuit 310 can transmit one or more signals at a first rate or in accordance with a first communication protocol. As another example, while the bike 200 is located in the zone 405b, the processing circuit 310 can transmit one or more signals at a second rate or in accordance with a second communication protocol.

The processing circuit 310 can utilize one or more transmission rates or communication protocols to dictate a response frequency for the bike 200. For example, the processing circuit 310 can, with the distance 410 having a first value, prompt the bike 200 for location information every 30 seconds. As another example, the processing circuit 310 can, with the distance 410 having a second value that is less than the first value, prompt the bike 200 for location information every 15 seconds. As even another example, the processing circuit 310 can, with the bike 200 in a given zone 405, transmit one or more signals for subsequent detection by the sensors 160. Stated otherwise, upon the distance 410 reaching a given value, the processing circuit 310 can transmit signals, for subsequent detection by the sensors 160, such that the processing circuit 310 can determine the position of the bike 200.

The processing circuit 310 can control the movement or the operation of the electric vehicle 105 to prevent one or more changes to the distance 410. For example, the processing circuit 310 can decrease a speed (e.g., control) of the electric vehicle 105 such that the distance 410 remains at or above a given threshold. As another example, the processing circuit 310 can maneuver the electric vehicle 105 to move from a first lane to a second lane such that the distance 410 is adjusted. The processing circuit 310 can monitor one or more changes to the position of the bike 200 using data collected by the sensors 160 or transmitted by the bike 200. For example, the processing circuit 310 can continuously or semi-continuously emit one or more signals for subsequent detection by the sensors 160. Stated otherwise, the processing circuit 310 can emit radio waves or light waves that are detectable by the sensors 160. The processing circuit 310 can, based on the sensors 160 having detected reflections or bounce backs of the radio waves or the light waves, determine one or more changes to the position of the bike 200.

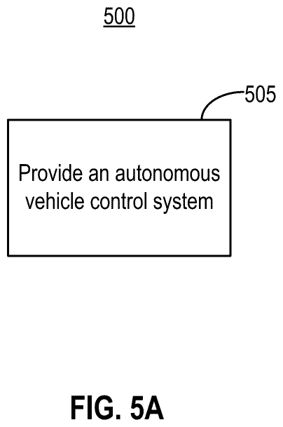

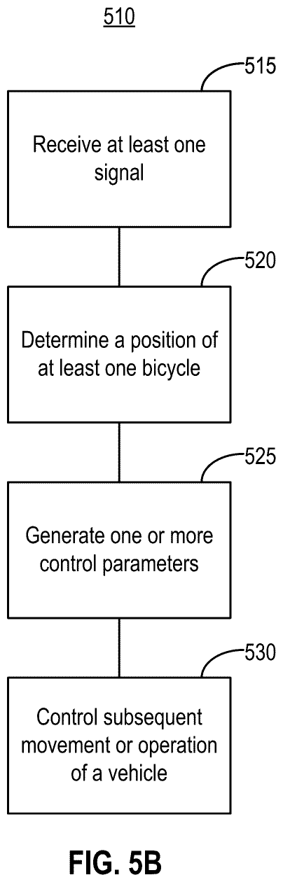

FIG. 5A is a flow diagram of a process 500, in accordance with some aspects. The process 500 can include manufacturing, providing, packaging, or otherwise making available at least one component described herein. For example, the process 500 can include the packaging of the autonomous vehicle control system 155. As another example, the process 500 can include placing or otherwise situating the sensors 160 on the electric vehicle 105.

At act 505, an autonomous vehicle control system can be provided. For example, an autonomous vehicle control system having the processing circuit 310 can be provided to the electric vehicle 105. As another example, the system architecture 300 (which includes the autonomous vehicle control system 155) can be implemented by the electric vehicle 105 or one or more components thereof. The autonomous vehicle control system can be provided by at least one of integrating, compiling, assembling, or otherwise adding the autonomous vehicle control system to the electric vehicle 105.

FIG. 5B is a flow diagram of a process 510, in accordance with some aspects. The process 510 or one or more acts thereof can be performed by at least one system, device, circuitry, component, assembly, or module described herein. For example, the processing circuit 310 can perform or implement at least one act of the process 510. The process 510 or one or more acts thereof can be repeated, replicated, omitted, reproduced, skipped, modified, separated, combined, or otherwise changed.

At act 515, at least one signal can be received. For example, the autonomous vehicle control system 155 can receive at least one signal from the bike 200. The at least one signal can include or indicate data associated with the bike 200. For example, the bike 200 can transmit a beacon or other signal which provides an indication of a location or position of the bike 200. As another example, the bike 200 can transmit one or more radio waves for which the sensors 160 can detect or otherwise receive. The at least one signal can be transmitted responsive to a prompt by the autonomous vehicle control system 155.

At act 520, a position of at least one bicycle can be determined. For example, the autonomous vehicle control system 155 can determine the position of the bike 200 based on the data received in act 515. As another example, the autonomous vehicle control system 155 can emit, via the communication device 315, one or more pulses or pings to detect a position of the bike 200. The autonomous vehicle control system 155 can determine the position of the bike 200 with respect to one or more objects. For example, the autonomous vehicle control system 155 can determine the position of the bike 200 with respect to or relative to the electric vehicle 105.

At act 525, one or more control parameters can be generated. For example, the autonomous vehicle control system 155 can generate one or more control parameter to control subsequent operation of the electric vehicle 105. As another example, the autonomous vehicle control system 155 can generate one or more input signals for distribution to one or more electronic control units of the electric vehicle 105. The autonomous vehicle control system 155 can generate control parameters for one or more systems or components of the electric vehicle 105. For example, the autonomous vehicle control system 155 can generate control parameters for at least one of a drivetrain of the electric vehicle 105, a braking system of the electric vehicle 105, or a steering component of the electric vehicle 105.

At act 530, subsequent movement or operation of a vehicle can be controlled. For example, the autonomous vehicle control system 155 can control subsequent movement of the electric vehicle 105 using the control parameters generated in act 525. The autonomous vehicle control system 155 can control movement or operation of the electric vehicle 105 by causing one or more components to perform or halt a performance of one or more actions.

For example, the autonomous vehicle control system 155 can control operation of the electric vehicle 105 by activating a braking system to decrease or lower a speed of the electric vehicle 105. As another example, the autonomous vehicle control system 155 can control movement of the electric vehicle 105 by activating a steering component of the electric vehicle 105 to cause the electric vehicle to change lanes.

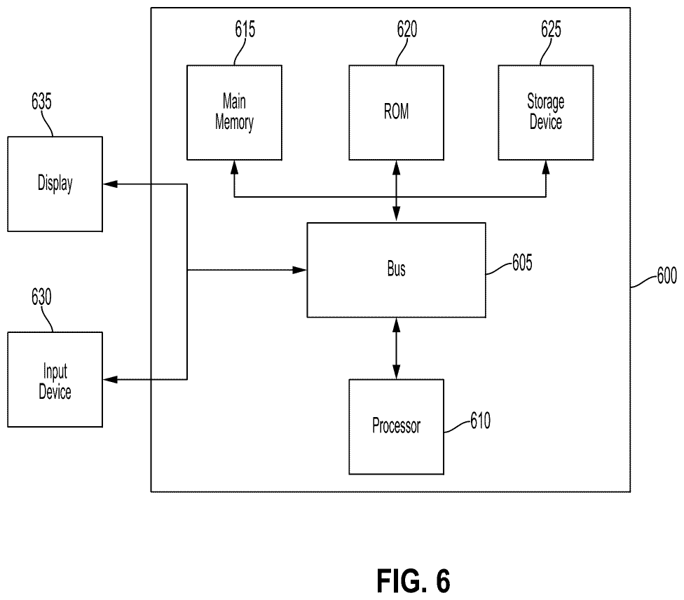

FIG. 6 is a block diagram illustrating an architecture for a computer system 600 that can be employed to implement elements of the systems, methods, and assemblies described and illustrated herein. For example, the computer system 600 can be included in or provided with the processing circuit 230. The computing system 600 can include at least one bus 605 or other communication component for communicating information and at least one processor 610 or processing circuit coupled to the bus 605 for processing information. The computing system 600 can also include one or more processors 610 or processing circuits coupled to the bus for processing information. The computing system 600 also includes at least one main memory 615, such as a random access memory (RAM) or other dynamic storage device, coupled to the bus 605 for storing information, and instructions to be executed by the processor 610. The main memory 615 can be used for storing information during execution of instructions by the processor 610. The computing system 600 may further include at least one read only memory (ROM) 620 or other static storage device coupled to the bus 605 for storing static information and instructions for the processor 610. A storage device 625, such as a solid state device, magnetic disk or optical disk, can be coupled to the bus 605 to persistently store information and instructions.

The computing system 600 may be coupled via the bus 605 to a display 635, such as a liquid crystal display, or active matrix display, for displaying information to a user such as a rider of the bike 200 or other end user. An input device 630, such as a keyboard or voice interface may be coupled to the bus 605 for communicating information and commands to the processor 610. The input device 630 can include a touch screen display 635. The input device 630 can also include a cursor control, such as a mouse, a trackball, or cursor direction keys, for communicating direction information and command selections to the processor 610 and for controlling cursor movement on the display 635.

The processes, systems and methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. Hard-wired circuitry can be used in place of or in combination with software instructions together with the systems and methods described herein. Systems and methods described herein are not limited to any specific combination of hardware circuitry and software.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

Further relative parallel, perpendicular, vertical, or other positioning or orientation descriptions include variations within +/−10% or +/−10 degrees of pure vertical, parallel, or perpendicular positioning. References to “approximately,” “substantially,” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A vehicle, comprising:
a communication device configured to communicate with at least one bicycle; and
an autonomous vehicle control system, comprising:
one or more processors, coupled with memory, to:
receive, via the communication device, from a transmitter of the at least one bicycle, at least one signal which includes data associated with the at least one bicycle;
implement, responsive to receipt of the at least one signal, signal triangulation using a plurality of sensors of the vehicle, wherein the signal triangulation compares respective points in time at which each of the plurality of sensors detect the at least one signal transmitted by the transmitter of the at least one bicycle;
determine, based at least on implementation of the signal triangulation, position of the at least one bicycle with respect to a position of the vehicle;
generate, responsive to determination of the position of the at least one bicycle, one or more control parameters for at least one of a drivetrain of the vehicle, a braking system of the vehicle, or a steering component of the vehicle; and
control subsequent movement or operation of the vehicle in accordance with the one or more control parameters.

2. The vehicle of claim 1, wherein the data associated with the at least one bicycle includes an identification of one or more communication protocols or one or more communication devices for which the at least one bicycle is configured to implement, and wherein the one or more processors further:
transmit, via the communication device, at least one second signal to the at least one bicycle to prompt the at least one bicycle to transmit the at least one signal;
detect, responsive to receipt of the at least one signal, the identification of the one or more communication protocols or the one or more communication devices; and
transmit, via the communication device, at least one third signal in accordance with the one or more communication protocols or the one or more communication devices.

3. The vehicle of claim 1, wherein the one or more processors further:
control the subsequent movement or operation of the vehicle to:
adjust a speed of the vehicle;
adjust a direction of travel of the vehicle; or
cause an audible device of the vehicle to produce an output.

4. The vehicle of claim 1, wherein the one or more processors further:
extract, from the data associated with the at least one bicycle, information which indicates at least one of:
a direction of travel of the at least one bicycle;
a speed of the at least one bicycle; or
global positioning system (GPS) coordinates of the at least one bicycle.

5. The vehicle of claim 1, wherein the at least one signal is received at a point in time, and wherein the one or more processors further:
transmit, responsive to a predetermined amount of time having elapsed since the point in the time and via the communication device, a prompt to the at least one bicycle for subsequent information; and
receive, from the at least one bicycle, at least one second signal to provide the subsequent information which indicates a change in the position of the at least one bicycle or a change in operation of the at least one bicycle.

6. The vehicle of claim 1, comprising:
the plurality of sensors configured to:
collect data associated with a plurality of zones which surround or include the vehicle; and
provide the data associated with the plurality of zones to the one or more processors;
wherein the one or more processors further:
receive, from the plurality of sensors, the data associated with the plurality of zones;
detect, responsive to an analysis of at least a portion of the data associated with the plurality of zones, the at least one bicycle within a first zone of the plurality of zones; and
transmit, via the communication device, a prompt to the at least one bicycle to transmit that at least one signal to provide the data associated with the at least one bicycle.

7. The vehicle of claim 1, wherein the one or more processors further:
receive, from at least one sensor of the plurality of sensors of the vehicle, data associated with at least one first zone which surrounds or includes the vehicle, the at least one first zone having a first dimension;
detect, responsive to an analysis of the data associated with the at least one first zone, that the at least one bicycle is within the at least one first zone;
transmit, via the communication device, using a first communication protocol, a first prompt to the at least one bicycle to transmit the at least one signal to provide the data associated with the at least one bicycle;
detect, responsive to receipt of data associated with at least one second zone, that the at least one bicycle is within the at least one second zone, wherein the at least one second zone includes a second dimension less than the first dimension; and
transmit, via the communication device, using a second communication protocol, a second prompt to the at least one bicycle to provide subsequent data to determine a change in the position of the at least one bicycle.

8. The vehicle of claim 1, wherein the one or more processors further:
control the subsequent movement or operation of the vehicle to prevent a distance between the vehicle and the at least one bicycle from being less than a predetermined distance; and
monitor, based on subsequent data collected by the plurality of sensors of the vehicle or transmitted by the at least one bicycle, one or more changes to the position of the at least one bicycle.

9. An autonomous vehicle control system, comprising:
one or more processors, coupled with memory, to:
receive, via a communication device of a vehicle, from a transmitter of at least one bicycle, at least one signal which includes data associated with the at least one bicycle;
implement, responsive to receipt of the at least one signal, signal triangulation using a plurality of sensors of the autonomous vehicle control system, wherein the signal triangulation compares respective points in time at which each of the plurality of sensors detect the at least one signal transmitted by the transmitter of the at least one bicycle;
determine, based at least on implementation of the signal triangulation, a position of the at least one bicycle with respect to a position of the vehicle;
generate, responsive to determination of the position of the at least one bicycle, one or more control parameters for at least one of a drivetrain of the vehicle, a braking system of the vehicle, or a steering component of the vehicle; and
control subsequent movement or operation of the vehicle in accordance with the one or more control parameters.

10. The autonomous vehicle control system of claim 9, wherein the data associated with the at least one bicycle includes an identification of one or more communication protocols or one or more communication devices for which the at least one bicycle is configured to implement, and wherein the one or more processors further:
transmit, via the communication device, at least one second signal to the at least one bicycle to prompt the at least one bicycle to transmit the at least one signal;
detect, responsive to receipt of the at least one signal, the identification of the one or more communication protocols or the one or more communication devices; and
transmit, via the communication device, at least one third signal in accordance with the one or more communication protocols or the one or more communication devices.

11. The autonomous vehicle control system of claim 9, wherein the one or more processors further:
control the subsequent movement or operation of the vehicle to:
adjust a speed of the vehicle;
adjust a direction of travel of the vehicle; or
cause an audible device of the vehicle to produce an output.

12. The autonomous vehicle control system of claim 9, wherein the one or more processors further:
extract, from the data associated with the at least one bicycle, information which indicates at least one of:
a direction of travel of the at least one bicycle;
a speed of the at least one bicycle; or
global positioning system (GPS) coordinates of the at least one bicycle.

13. The autonomous vehicle control system of claim 9, wherein the at least one signal is received at a point in time, and wherein the one or more processors further:
transmit, responsive to a predetermined amount of time having elapsed since the point in the time and via the communication device, a prompt to the at least one bicycle for subsequent information; and
receive, from the at least one bicycle, at least one second signal to provide the subsequent information which indicates a change in the position of the at least one bicycle or a change in operation of the at least one bicycle.

14. The autonomous vehicle control system of claim 9, wherein the plurality of sensors are configured to collect data associated with a plurality of zones which surround or include the vehicle and provide the data associated with the plurality of zones to the one or more processors, and wherein the one or more processors further:
receive, from the plurality of sensors, the data associated with the plurality of zones;
detect, responsive to an analysis of at least a portion of the data associated with the plurality of zones, the at least one bicycle within a first zone of the plurality of zones; and
transmit, via the communication device, a prompt to the at least one bicycle to transmit that at least one signal to provide the data associated with the at least one bicycle.

15. The autonomous vehicle control system of claim 9, wherein the one or more processors further:
receive, from at least one sensor of the plurality of sensors, data associated with at least one first zone which surrounds or includes the vehicle, the at least one first zone having a first dimension;
detect, responsive to an analysis of the data associated with the at least one first zone, that the at least one bicycle is within the at least one first zone;
transmit, via the communication device, using a first communication protocol, a first prompt to the at least one bicycle to transmit the at least one signal to provide the data associated with the at least one bicycle;
detect, responsive to receipt of data associated with at least one second zone, that the at least one bicycle is within the at least one second zone, wherein the at least one second zone includes a second dimension less than the first dimension; and
transmit, via the communication device, using a second communication protocol, a second prompt to the at least one bicycle to provide subsequent data to determine a change in the position of the at least one bicycle.

16. The autonomous vehicle control system of claim 9, wherein the one or more processors further:
control the subsequent movement or operation of the vehicle to prevent a distance between the vehicle and the at least one bicycle from being less than a predetermined distance; and
monitor, based on subsequent data collected by the plurality of sensors or transmitted by the at least one bicycle, one or more changes to the position of the at least one bicycle.

17. A method, comprising:
receiving, by one or more processors of an autonomous vehicle control system for a vehicle, via a communication device, from a transmitter of at least one bicycle, at least one signal which includes data associated with the at least one bicycle;
implementing, by the one or more processors, responsive to receiving the at least one signal, signal triangulation using a plurality of sensors of the vehicle, wherein the signal triangulation compares respective points in time at which each of the plurality of sensors detect the at least one signal transmitted by the transmitter of the at least one bicycle;
determining, by the one or more processors, based at least on implementing the signal triangulation, a position of the at least one bicycle with respect to a position of the vehicle;
generating, by the one or more processors, responsive to determining the position of the at least one bicycle, one or more control parameters for at least one of a drivetrain of the vehicle, a braking system of the vehicle, or a steering component of the vehicle; and
controlling, by the one or more processors, subsequent movement or operation of the vehicle in accordance with the one or more control parameters.

18. The method of claim 17, wherein the data associated with the at least one bicycle includes an identification of one or more communication protocols or one or more communication devices for which the at least one bicycle is configured to implement, and comprising:
transmitting, by the one or more processors, via the communication device, at least one second signal to the at least one bicycle to prompt the at least one bicycle to transmit the at least one signal;
detecting, by the one or more processors, responsive to receiving the at least one signal, the identification of the one or more communication protocols or the one or more communication devices; and
transmitting, by the one or more processors, via the communication device, at least one third signal in accordance with the one or more communication protocols or the one or more communication devices.

19. The method of claim 17, comprising:
controlling, by the one or more processors, the subsequent movement or operation of the vehicle to:
adjust a speed of the vehicle;
adjust a direction of travel of the vehicle; or
cause an audible device of the vehicle to produce an output.

20. The method of claim 17, comprising:
extracting, by the one or more processors, from the data associated with the at least one bicycle, information that indicates at least one of:
a direction of travel of the at least one bicycle;
a speed of the at least one bicycle; or
global positioning system (GPS) coordinates of the at least one bicycle.

21. The vehicle of claim 1, comprising the one or more processors configured to:
receive the data associated with the at least one bicycle, the data including information about at least one operational characteristic of the at least one bicycle, the at least one operational characteristic including at least one of direction of travel, heading, movement, or speed of the at least one bicycle.

22. The autonomous vehicle control system of claim 9, comprising the one or more processors configured to:
receive the data associated with the at least one bicycle, the data including information about at least one of direction of travel, heading, movement, or speed of the at least one bicycle.
